(19) United States
(12) Patent Application Publication
(10) Pub. No.: US 2024/0114436 A1
(43) Pub. Date: Apr. 4, 2024

(54) BEACONING WITH RANGE EXTENSION

(71) Applicant: NXP USA, Inc., Austin, TX (US)

(72) Inventors: Liwen Chu, San Ramon, CA (US); Rui Cao, Sunnyvale, CA (US); Kiseon Ryu, San Diego, CA (US); Hongyuan Zhang, Fremont, CA (US)

(21) Appl. No.: 18/480,693

(22) Filed: Oct. 4, 2023

Related U.S. Application Data
(60) Provisional application No. 63/378,321, filed on Oct. 4, 2022.

(51) Int. Cl. H04W 48/10; H04B 7/155; H04L 12/18

(52) U.S. Cl. CPC H04W 48/10; H04B 7/15507; H04L 12/1868

(57) ABSTRACT

A method of broadcasting a beacon by a relay device in a basic service set, including: receiving an announcement from a first device indicating whether the relay device is to forward a received beacon to a second device; receiving a beacon from the first device; and forwarding the beacon to the second device based upon the announcement.

### CROSS-REFERENCE TO RELATED APPLICATIONS

This application claims the benefit of U.S. Provisional Patent Application No. 63/378,321, filed Oct. 4, 2022, the contents of which is incorporated for all purposes by reference herein in its entirety.

### FIELD OF THE DISCLOSURE

Various exemplary embodiments disclosed herein relate to beaconing with range extension.

### SUMMARY

A summary of various exemplary embodiments is presented below.

Various embodiments relate to a method of broadcasting a beacon by a relay device in a basic service set, including: receiving an announcement from a first device indicating whether the relay device is to forward a received beacon to a second device; receiving a beacon from the first device; and forwarding the beacon to the second device based upon the announcement.

Various embodiments are described, further including: receiving a ultra-high reliability (UHR) PHY protocol data unit (PPDU) from the first device that announces the forwarding of the beacon.

Various embodiments are described, wherein the beacon is forwarded after a short interframe space (SIFS) amount of time after an end of the received UHR PPDU.

Various embodiments are described, wherein a SERVICE field of a PPDU carrying the beacon transmitted by the relay device is same as a SERVICE field of the PPDU carrying the beacon received by the second device.

Various embodiments are described, further including: receiving from the first device a multi-user request to send (MU-RTS) frame; sending a clear to send (CTS) frame to the first device; and guaranteeing an interframe space (IFS) accuracy between the PPDU carrying the received beacon and the PPDU carrying the forwarded beacon to be same as the IFS accuracy of the CTS frame and the MU-RTS frame.

Various embodiments are described, further including adjusting a timestamp of the forwarded beacons based upon a timestamp in the received beacon, a length of the beacon, a predefined interframe space (IFS) time, and a number of hops between the first device and the relay device.

Various embodiments are described, wherein the forwarded beacon includes an indication that the forwarded beacon is a forwarded beacon.

Various embodiments are described, wherein the forwarded beacon only carries information of the first device.

Various embodiments are described, further including: sending a broadcast management frame announcing the information of a relay station to the second device.

Various embodiments are described, wherein the forwarded beacon carries information of the first device and the relay device.

Various embodiments are described, wherein forwarding the beacon to the second device using a backoff procedure and a target beacon transmission time (TBTT) of the first device.

Various embodiments are described, wherein forwarding the beacon to the second device using a backoff procedure and a target beacon transmission time (TBTT) of the relay device.

Various embodiments are described, further including: receiving first block acknowledge from the second device indicating that a PHY protocol data unit (PPDU) from the first device was received by the second device; and transmitting a second block acknowledge to the first device indicating that a PHY protocol data unit (PPDU) from the first device was received by the second device.

Further various embodiments relate to a method of determining by a station whether to use a relay station in communication with an access point, including: receiving an ultra-high reliability (UHR) PHY protocol data unit (PPDU) from the access point; determining a first received signal strength indicator (RSSI) of the access point based on the received UHR PPDU from the access point; receiving a PPDU from a first relay station; determining a second RSSI of the first relay station based on the received PPDU from the relay station; and determining whether to use the relay station to communicate with the access point based upon the first RSSI and the second RSSI.

Various embodiments are described, further including: receiving a PPDU from a second relay station; determining a third RSSI of the second relay station based on the received PPDU from the second relay station; and determining whether to use the first relay station or the second relay station to communicate with the access point based upon the second RSSI and the third RSSI.

Further various embodiments relate to a method of broadcasting a beacon by an access point to a relay station in a basic service set, including: sending an announcement to the relay station indicating whether the relay station is to forward a received beacon to a leaf station; sending a multi-user request to send (MU-RTS) frame; receiving a clear to send (CTS) frame from the relay station; and sending a beacon to the relay station.

Various embodiments are described, wherein sending the beacon to the relay station includes sending an ultra-high reliability (UHR) PHY protocol data unit (PPDU) to the relay station that announces forwarding of the beacon.

Various embodiments are described, wherein a SERVICE field of the UHR PPDU is configured to carry the beacon transmitted by the access point.

Various embodiments are described, further including: receiving a block acknowledge from the relay station indicating a reception of the UHR PPDU by the relay station.

Various embodiments are described, further including: receiving block acknowledge from the relay station indicating a reception of the UHR PPDU by the relay station.

The foregoing has outlined rather broadly the features and technical advantages of examples according to the disclosure in order that the detailed description that follows may be better understood. Additional features and advantages will be described hereinafter. The conception and specific examples disclosed may be utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram of an example wireless local area network (WLAN) 10, according to an embodiment.

FIG. 2 illustrates a leaf station (LSTA) communicating with an AP according to an embodiment.

FIG. 3 illustrates an upload (UL) frame transmission between the AP and the LSTA according to an embodiment.

FIG. 4 illustrates the rSTA forwarding a beacon from the AP according to an embodiment.

FIG. 5 illustrates the UHR PPDU that announces the beacon forwarding to the rSTA according to an embodiment.

FIG. 6 illustrates a rSTA transmitting a beacon after a backoff procedure according to an embodiment.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of WiFi systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

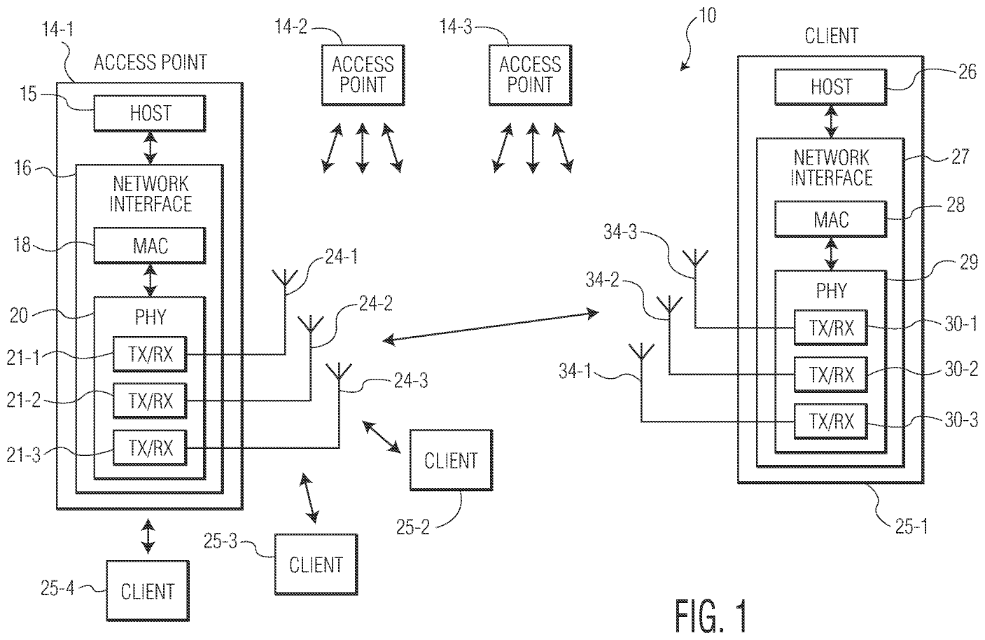

FIG. 1 is a block diagram of an example wireless local area network (WLAN) 10, according to an embodiment. Such a WLAN 10 may need to be able to update operating parameters across a range of different versions of Wi-Fi or IEEE 802.11. An access point (AP) 14-1 includes a host processor 15 coupled to a network interface 16. The network interface 16 includes a medium access control (MAC) processing unit 18 and a physical layer (PHY) processing unit 20. The PHY processing unit 20 includes a plurality of transceivers 21, and the transceivers 21 are coupled to a plurality of antennas 24. Although three transceivers 21 and three antennas 24 are illustrated in FIG. 1, the AP 14 may include different numbers (e.g., 1, 2, 4, 5, etc.) of transceivers 21 and antennas 24 in other embodiments. The WLAN 10 may include multiple APs 14-1, 14-2, 14-3 as shown, but any number of APs 14 may be included in WLAN 10.

The WLAN 10 includes a plurality of client stations (STA) 25. Although four client stations 25 are illustrated in FIG. 1, the WLAN 10 may include different numbers (e.g., 1, 2, 3, 5, 6, etc.) of client stations 25 in various scenarios and embodiments. The WLAN 10 may also include AP multi-link device (MLD) where one AP MLD includes multiple affiliated APs and client STA multi-link devices (MLD) where one non-AP MLD includes multiple affiliated STAs. Two or more of the STAs of a non-AP MLD 25 are configured to receive corresponding data streams that are transmitted simultaneously by the AP 14. Additionally, two or more of the STAs of a non-AP MLD 25 are configured to transmit corresponding data streams to one AP MLD 14 such that the AP MLD 14 simultaneously receives the data streams. Also, the client station MLD 25 are configured to receive data streams that are transmitted simultaneously by multiple APs of one AP MLD 14. Likewise, the STAs of a non-AP MLD 25 may transmit data streams simultaneously to the multiple APs of an AP MLD 14. MLD devices and operation will be described in more detail below.

A client station 25-1 includes a host processor 26 coupled to a network interface 27. The network interface 27 includes a MAC processing unit 28 and a PHY processing unit 29. The PHY processing unit 29 includes a plurality of transceivers 30, and the transceivers 30 are coupled to a plurality of antennas 34. Although three transceivers 30 and three antennas 34 are illustrated in FIG. 1, the client station 25-1 may include different numbers (e.g., 1, 2, 4, 5, etc.) of transceivers 30 and antennas 34 in other embodiments.

In an embodiment, one or more of the client stations 25-2, 25-3, and 25-4 has a structure the same as or similar to the client station 25-1. In these embodiments, the client stations 25 structured like the client station 25-1 have the same or a different number of transceivers and antennas. For example, the client station 25-2 has only two transceivers and two antennas (not shown), according to an embodiment.

In an embodiment, the APs 14 and the client stations 25 contend for communication medium using carrier sense multiple access with collision avoidance (CSMA/CA) protocol or another suitable medium access protocol. Further, in an embodiment, the APs 14 or a client station 25 dynamically selects a bandwidth for a transmission based on channels available for the transmission.

In an embodiment, the APs 14 are configured to simultaneously transmit different orthogonal frequency division multiplexing (OFDM) units to different client stations 25 by forming an orthogonal frequency division multiple access (OFDMA) resource unit (RU) that includes the different OFDM RUs modulated in respective sub-channel blocks of the OFDMA RU. In an embodiment, the AP 14 allocates different sub-channels to different client stations and forms the OFDMA RU that includes OFDM RUs directed to by modulating the different client stations in sub-channel blocks corresponding to the sub-channels assigned to the client stations.

In an embodiment, the APs 14 are configured to simultaneously transmit different OFDM units to different client stations 25 by transmitting the different OFDM RUs via different space time streams of a MU-MIMO communication channel to a single user (SU) or multiple users. In an embodiment, the APs 14 allocates different sub-channels and space time streams to different client stations and forms the OFDM RUs and modulates the different OFDM RUs to the space time streams corresponding to the sub-channels assigned to the client stations.

Various iterations of the 802.11 specification are referred to herein. IEEE 802.11ac is referred to as very high throughput (VHT). IEEE 802.11ax is referred to as high efficiency (HE). IEEE 802.11be is referred to as extreme high throughput (EHT). IEEE 802.11bn is referred to as ultra-high reliability (UHR). The terms VHT, HE, EHT, and UHR will be used in the descriptions found herein.

As described above a multi-link AP MLD has multiple links where each link has one AP affiliated with the AP MLD. This may be accomplished by having two different radios.

A multi-link STA MLD has one or multiple links where each link has one STA affiliated with the STA MLD. One way to implement the multi-link STA MLD is using two or more radios, where each radio is associated with a specific link. For example, an enhanced multi-link multi-radio (eMLMR) non-AP MLD may be used. The eMLMR non-AP MLD uses multiple full functional radios to monitor the medium in multiple links. Another way to implement the multi-link STA MLD is using a single radio in two different bands. Each band may be associated with a specific link. In this case only one link is available at a time. In yet another implementation, an enhanced single-radio (ESR) STA MLD may be used that operates in an enhanced multi-link single radio (eMLSR) mode. The ESR STA MLD uses two radios in different bands to implement the MLD. For example, one radio may be a lower cost radio with lesser capabilities and the other radio may be a fully functional radio supporting the latest protocols. The ESR STA MLD may dynamically switch its working link while it can only transmit or receive through one link at any time. The ESR STA MLD may monitor two links simultaneously, for example, detecting medium idle/busy status of each link, or receiving a PHY protocol data unit (PPDU) on each link. Each radio may have its own backoff time, and when the backoff counter for one of the radios becomes zero that radio and link may be used for transmission. For example, if an AP wants to use the fully functional radio, it may send a control frame that is long enough for the ESR STA MLD to switch from the lesser capable radio to the fully functional radio that may then transmit data to the AP.

In embodiments of a wireless communications system, a wireless device, e.g., an AP MLD of the WLAN may transmit data to at least one associated STA MLD. The AP MLD may be configured to operate with associated STA MLDs according to a communication protocol. For example, the communication protocol may be an Extremely High Throughput (EHT) communication protocol. Features of wireless communications and multi-link communication systems operating in accordance with the EHT communication protocol and/or next-generation communication protocols may be referred to herein as “non-legacy” features. In some embodiments of the wireless communications system described herein, different associated STAs within range of an AP operating according to the EHT communication protocol are configured to operate according to at least one other communication protocol, which defines operation in a BSS with the AP, but are generally affiliated with lower data throughput protocols. The lower data throughput communication protocols (e.g., HE, VHT, etc.) may be collectively referred to herein as “legacy” communication protocols.

An AP MLD in multi-link operation may remove its links through MLD reconfiguration. Multi-link (ML) reconfiguration broadly refers to a set of post-association procedures to make changes to links between APs and non-AP STAs affiliated with two MLDs including adding or removing links, and without disassociation. This may be accomplished using the reconfiguration multi-link element in a beacon frame. As a result, the AP MLD may have only one link after link removal. Also, a mobile AP MLD may only have one link because often these devices are power constrained, and the use of only a single link saves power. If an AP MLD with multiple links and a non-AP MLD with multiple links have one common link, they may do association through the common link. When links are removed, how the MLD operates with the single link is ambiguous under the current standards and should be clarified, e.g. whether the BSS Parameter Change Count and Critical Update Flag are mandatory requirement at the single-link non-AP MLD, whether the EMLSR mode is still used at non-AP MLD, and whether the radio switch padding delay is still needed for the first control frame addressed to an EMLSR non-AP MLD.

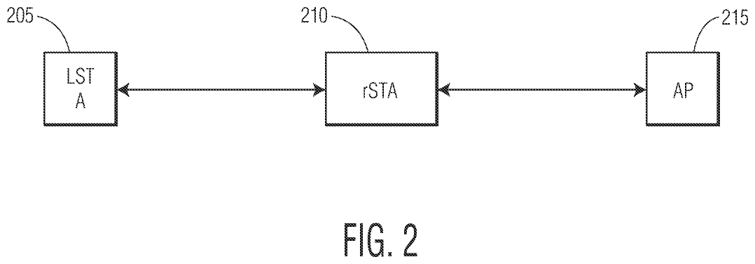

A relay STA (rSTA) may be used when an associated AP cannot reach a faraway STA with a high MCS or Nss. A rSTA may also be used when the AP cannot reach a faraway STA with the lowest MCS. FIG. 2 illustrates a leaf station (LSTA) 205 communicating with an AP 215 according to an embodiment. In this situation a rSTA 210 is used to forward communications from the LSTA 205 to the AP 215 and vice versa. As described above the rSTA 210 may be used when the LSTA 205 and the AP 215 are not able to directly communicate with one another effectively because of the distance between them. The rSTA 210 will allow for a higher data rate communication between the LSTA 205 and AP 215. The AP 215 is typically able to operate with higher power and antenna gain than the 210. It is noted that in FIG. 2 the use of just one rSTA 210 is illustrated, but any number of rSTAs 210 may be used to connect the LSTA 205 and the AP 215.

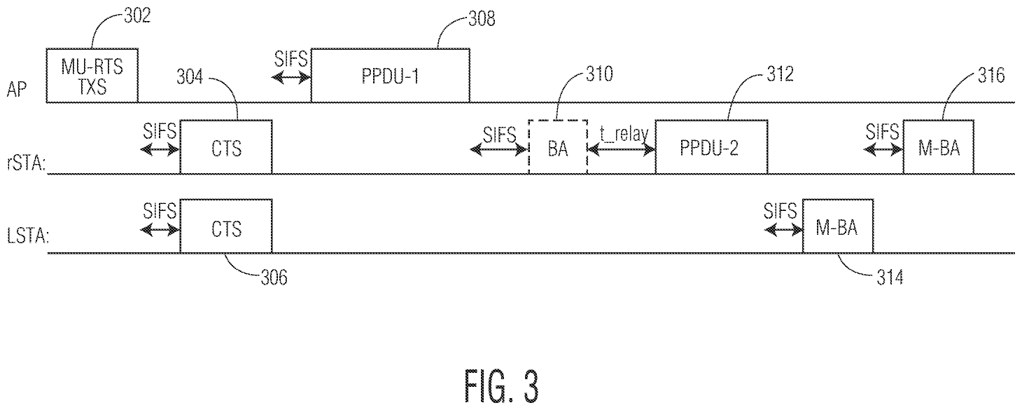

FIG. 3 illustrates an upload (UL) frame transmission between the AP 215 and the LSTA 205 according to an embodiment. The AP 215 first sends a multi-user request to send (MU-RTS) triggered transmission opportunity sharing (TXS) 302 to the rSTA 210. Next after a short interframe space (SIFS) period, the rSTA 210 sends a clear to send (CTS) 304, and the LSTA 205 sends a CTS 306 in response to the MU-RTS TXS 302. This indicates that the channel is clear. Then the AP 215 transmits a PPDU-1 after a SIFS period. The rSTA 210 then sends a BA 310 after a SIFS period. It is noted that the sending of the BA 310 is optional. After a t_relay period of time, the rSTA 210 may then send a PPDU-2 312 to the LSTA 205. PPDU-2 312 forwards the information of the PPDU-1 308 to the LSTA 205. Then the LSTA 205 sends a multi-STA BS(M-B A) 314 back to the rSTA 210 acknowledging the receipt of the PPDU-2 312. Finally, the rSTA 210 sends a M-BA 316 back to the AP 215 acknowledging the receipt of the PPDU-1 308. It is noted that with the use of the rSTA 210, a higher MCS may be used allowing for higher throughput between the LSTA 205 and the AP 215 versus a direct wireless link between them.

The DL frame transmission between the AP 215 and LSTA 205 are carried out similar to the exchange illustrated in FIG. 3, but in reverse where PPDUs are transmitted by the AP 215 to the rSTA 210, and PPDUs are transmitted by rSTA 210 to LSTA 205.

To support communication between the AP 215 and the LSTA 205 via the rSTA 210, it must be considered how to transmit beacons between the AP 215 and the LSTA 205 when a rSTA 210 may be used. The BA/Ack may be carried out end-to-end or hop-by-hop. With an end-to-end BA, the DL BA transmitted by AP 215 acknowledges the soliciting UL A-MPDU/BAR from LSTA 205 that is forwarded by the rSTA 210. Likewise, the DL BA transmitted by AP 215 acknowledges the soliciting A-MPDU/BAR from the LSTA 205 that is forwarded by the rSTA 210. With hop-by-hop DL BA, the DL BA transmitted by AP 215 acknowledges the soliciting UL A-MPDU/BAR from the rSTA 210. Likewise, the DL BA transmitted by the rSTA 210 acknowledges the soliciting UL A-MPDU/BAR from LSTA 205.

With hop-by-hop UL BA, the UL BA transmitted by the rSTA 210 acknowledges the soliciting DL A-MPDU/BAR from the AP 215. Likewise, the UL BA transmitted by LSTA 205 acknowledges the soliciting DL A-MPDU/BAR from the rSTA 210.

In 802.11, the beacon frame is one of the management frames. The beacon frame contains all the information about the network. Beacon frames are transmitted periodically, and they serve to announce the presence of a wireless LAN and to synchronize the members of the service set. Beacon frames are transmitted by the AP in a basic service set (BSS). In a BSS network beacon generation is distributed among the stations.

The beacon frames may include the following components: 802.11 MAC header, frame body, and FCS. Some of the fields in the body may include a timestamp, beacon interval, capability information, service set identifier (SSID), supported rates, Frequency-hopping (FH) Parameter Set, Direct-Sequence (DS) Parameter Set, Contention-Free (CF) Parameter Set, infrastructure BSS (IBSS) Parameter Set, and Traffic indication map (TIM).

The timestamp is used to synchronize the stations local clocks. After receiving the beacon frame all the stations change their local clocks to the timestamp time.

The beacon interval is the time interval between beacon transmissions. The time at which an AP must schedule a beacon transmission is known as target beacon transmission time (TBTT). Beacon interval expressed in time unit (TU). It is a configurable parameter in the AP 215.

The capability information field spans to 16 bits and contains information about capability of the device/network. The type of network such as ad hoc or Infrastructure network is signaled in this field. Apart from this information, it announces the support for polling, as well as the encryption details.

The SSID provides the identifier for the BSS. The supported rates identifies the data rates supported by the device. The CF Parameter Set elements are included in beacon frames to keep all mobile stations apprised of contention-free operations. They are also included in Probe Response frames to allow stations to learn about contention-free options supported by a BSS. Various fields make up the CF Parameter Set information element.

IB SS Parameter Set element contains the set of parameters necessary to support an IB SS.

The TIM is a bitmap used to indicate to any sleeping listening stations that the AP has buffered data waiting for it. Because stations should listen to at least one beacon during the listen interval, the AP periodically sends this bitmap in its beacons as an information element. The bit mask is called the TIM and may include 2008 bits where each bit represents the association ID (AID) of a station.

During operation of a BSS, each AP schedules the beacon transmission at its TBTTs to synchronize stations that it communicates with as well as setting and updating parameters for the BSS. The beacon carries the AP's capabilities, BSS operating parameters etc. An associated STA with the AP synchronizes with the AP through the received beacons from the associated AP.

When using an AP 215 to facilitate communication between the AP 215 and the LSTA 205, the question of how to carry out beaconing arises when a rSTA 210 is used.

A first approach specifies whether the rSTA 210 broadcasts beacons or not. An AP 215 announces whether the rSTAs 210 in the BSS forward the beacons received from the AP 215, no transmission of the beacon received from the AP, or creates their beacons per the beacon received from the AP. This announcement is based on whether the beacons transmitted by the AP 215 by using a robust data rate and MCS can reach the associated LSTAs 205.

When the AP's beacon cannot reach the associated LSTAs 205, the AP 215 uses the rSTA 210 to get the beacons to the LSTA 205 by announcing that the associated RSTAs 210 forward the beacon or generate their own beacons. When the AP's beacons are not forwarded by RSTAs 210, the AP's beacons may carry the beacon information of RSTAs 210. Another option is that a RSTA 210 announces its information through a broadcast frame.

An associated LSTA 205 may decide whether it wants to transmit/receive frames to/from the AP 215 through a RSTA 210 depending upon the viable data rates and MCS that may be used. The AP 215 may decide whether to use the rSTA 210 to assist with beacon frames based upon the distances and locations of the LSTAs 205 and rSTAs 210 during setup of the BSS.

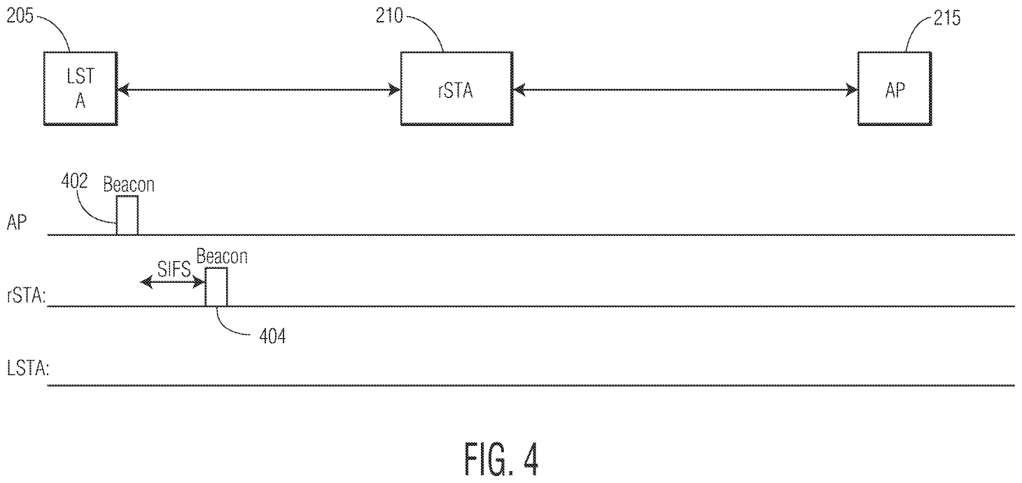

In a second approach, the rSTA 210 may copy any beacon it receives and forward the beacon information in a beacon frame that it transmits. For example, after a TBTT, a rSTA 210 forwards a beacon with a predefined inter-frame space (IFS), e.g. a SIFS, after the rSTA 210 receives the beacon with a traffic address (TA) equal to its associated AP 215 that is transmitted by its associated AP 215 or rSTA 210. FIG. 4 illustrates the rSTA 210 forwarding a beacon 402 from the AP 215 according to an embodiment. The AP 215 transmits a beacon 402 that is received by the rSTA 210. The rSTA 210 then transmits a beacon 404 with a SIFS time period between the end time of the receiving the beacon 402 and the start time to transmit the beacon 402 to the LSTA 205. All the RSTAs use the same data rate (e.g., the same data rate as AP's beacon transmission) to forward the beacon. As mentioned before, there may be multiple rSTAs 210 between the AP 215 and LSTA 205.

In a first option, the content of the forwarded beacon is the same as the received beacon. The LSTA 205 adjusts the timestamp per the number of hops to its associated AP 215. A LSTA 205 that is N hops away from the AP 215 will use Received_Timestamp+N*(Predefined_IFS+Beacon_Tx_Time) as the Timestamp to account for the delay in transmitting the beacon 404 to the LSTA 205, where the Received_Timestamp is the Timestamp in the received beacon, Predefined_IFS is a predefined IFS, the Beacon_Tx_Time is the received beacon transmit time.

In a second option, the content of the forwarded beacon is same as the received beacon with the following exception: the Timestamp in the forwarded beacon is equal to the sum of the Timestamp in the received beacon, predefined IFS, and the received beacon transmit time. That is the Timestamp from the rSTA 210 has been updated to accommodate for the delay in transmission so that the LSTA 205 does not need to make the adjustment.

Further, when a rSTA 210 forwards the AP's beacon 404, a forwarding indication may be added to the beacon 404, e.g., in the beacon frame body, in the frame header or in PHY header. Then the LSTA 205 knows that it is a forwarded beacon and can act accordingly. It is noted that in this scenario the LSTA 205 may also receive beacon 402 as well. Then the LSTA 205 can compare the information in beacon 402 and beacon 404 to know that they include the same information.

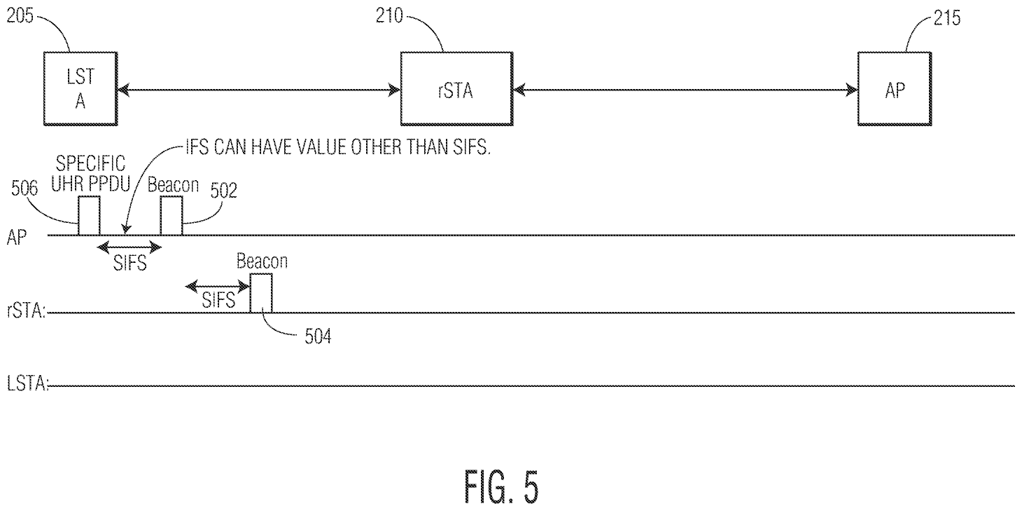

If the AP 215 requires the rSTA to forward its beacon, the AP 215 may schedule the transmission of a specific UHR PPDU to announce the following beacon transmission. The BSS Color or the other AP ID in UHR PPDU header may be used to identify that the AP 215 that transmits the UHR specific PPDU. FIG. 5 illustrates the UHR PPDU 506 that announces the beacon forwarding to the rSTA 210 according to an embodiment. The beacon 502 is then transmitted by the AP 215 after a SIFS time period to the rSTA 210. The rSTA 210 then forwards the beacon 502 by transmitting beacon 504 to the LSTA 205. The rSTA 210 detects the specific UHR PPDU from its associated AP 215 (per the AP's indication in UHR PPDU header) and the following beacon frame 504 will forward the received beacon frame 502. The PPDU of the forwarding beacon has the same content as the received PPDU. The SERVICE field of the PPDU that carries the forwarded beacon, and the SERVICE field of the received PPDU that carries the received beacon are same. The forwarded beacon 504 and the received beacon 502 are the same. For example they will have the same data rate, MCS, and scramble initial value. When the rSTA 210 forwards the received beacon frame 502, the rSTA 210 needs to guarantee the IFS accuracy to be same as the IFS accuracy when the CTS frame is transmitted when solicited by MU-RTS.

When the rSTA 210 copies the beacons from the AP 215 there are two options. In a first option, the beacon carries the AP's information only. Then the rSTA 210 announces its information through broadcast Management frame. In a second option, in the beacon frame, the AP announces the information of the rSTA 210 in its BSS in addition to the AP's information.

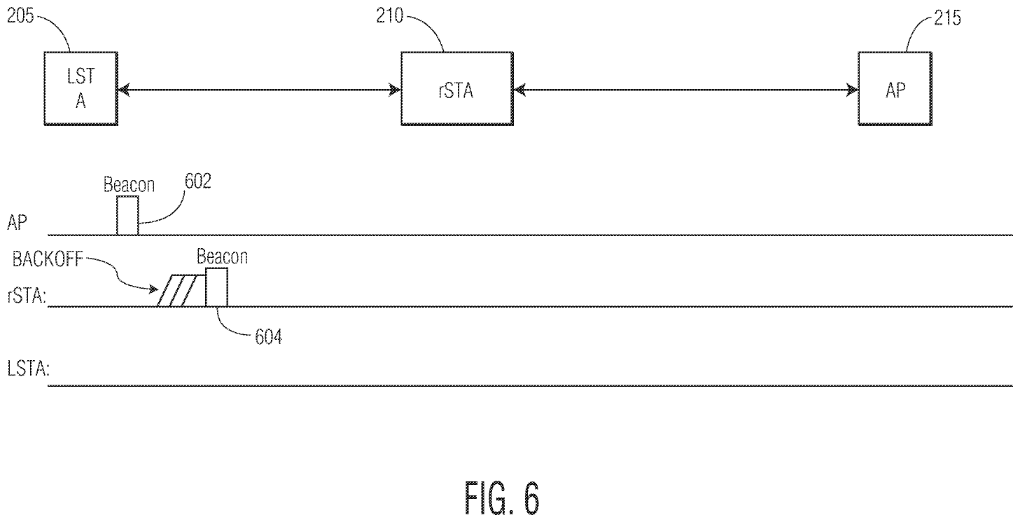

In a third approach the rSTA 210 beacon creation is carried out. After a TBTT, a rSTA 210 transmits a beacon through the backoff procedure. FIG. 6 illustrates a rSTA transmitting a beacon after a backoff procedure according to an embodiment. The AP 215 transmits a beacon 602 to the rSTA 210. The rSTA 210 then creates and transmits beacon 604 after a backoff period of time. The TBTT may be the TBTT of its associated AP 215 or the TBTT of the rSTA 210. Additional requirements of rSTA's beacon transmission could be that the rSTA 210 receives a beacon with a TA equal to its associated AP 215 and the rSTA 210 did not transmit the beacon after the TBTT. The Timestamp field carries the time synchronization function (TSF) time maintained by the rSTA 210 when the Timestamp field is transmitted through baseband/RF interface or other reference time agreed by the rSTA 210 and the LSTA 205.

In a fourth approach, a LSTA 205 selects whether to use a rSTA 210 and is so which rSTA 210 of a group of available rSTAs to use. When a LSTA 205 receives an unsolicited PPDU from a rSTA 210, the LSTA 205 may figure out the received signal strength indicator (RSSI) of the rSTA 210. A LSTA 205 may transmit a PPDU to a rSTA 210 to solicit the responding PPDU from the rSTA 210, and the LSTA 205 can figure out the RSSI of the rSTA 210 per the received PPDU from the RSTA Likewise, the LSTA 205 may determine the RSSI of the AP 215 based upon PPDUs received from the AP 215. A LSTA 205 uses the RSSI of the received PPDU from a rSTA 210 and the RSSI of the PPDU from AP 215 to decide whether it does association and data frame exchanges through a rSTA 210, and if so, which of multiple rSTAs 210 to use (if multiple rSTA 210 are present).

The foregoing disclosure provides illustration and description but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software.

As used herein, satisfying a threshold may, depending on the context, refer to a value being greater than the threshold, greater than or equal to the threshold, less than the threshold, less than or equal to the threshold, equal to the threshold, not equal to the threshold, and/or the like. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, the term “non-transitory machine-readable storage medium” will be understood to exclude a transitory propagation signal but to include all forms of volatile and non-volatile memory. When software is implemented on a processor, the combination of software and processor becomes a specific dedicated machine.

Because the data processing implementing the embodiments described herein is, for the most part, composed of electronic components and circuits known to those skilled in the art, circuit details will not be explained in any greater extent than that considered necessary as illustrated above, for the understanding and appreciation of the underlying concepts of the aspects described herein and in order not to obfuscate or distract from the teachings of the aspects described herein.

Unless stated otherwise, terms such as “first” and “second” are used to arbitrarily distinguish between the elements such terms describe. Thus, these terms are not necessarily intended to indicate temporal or other prioritization of such elements.

It should be appreciated by those skilled in the art that any block diagrams herein represent conceptual views of illustrative hardware embodying the principles of the aspects.

While each of the embodiments are described above in terms of their structural arrangements, it should be appreciated that the aspects also cover the associated methods of using the embodiments described above.

Unless otherwise indicated, all numbers expressing parameter values and so forth used in the specification and claims are to be understood as being modified in all instances by the term “about.” Accordingly, unless indicated to the contrary, the numerical parameters set forth in this specification and attached claims are approximations that may vary depending upon the desired properties sought to be obtained by embodiments of the present disclosure. As used herein, “about” may be understood by persons of ordinary skill in the art and can vary to some extent depending upon the context in which it is used. If there are uses of the term which are not clear to persons of ordinary skill in the art, given the context in which it is used, “about” may mean up to plus or minus 10% of the particular term.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

1. A method of broadcasting a beacon by a relay device in a basic service set, comprising:
receiving an announcement from a first device indicating whether the relay device is to forward a received beacon to a second device;
receiving a beacon from the first device; and
forwarding the beacon to the second device based upon the announcement.

2. The method of claim 1, further comprising:
receiving a ultra-high reliability (UHR) PHY protocol data unit (PPDU) from the first device that announces the forwarding of the beacon.

3. The method of claim 2, wherein the beacon is forwarded after a short interframe space (SIFS) amount of time after an end of the received UHR PPDU.

4. The method of claim 3, wherein a SERVICE field of a PPDU carrying the beacon transmitted by the relay device is same as a SERVICE field of the PPDU carrying the beacon received by the second device.

5. The method of claim 4, further comprising:
receiving from the first device a multi-user request to send (MU-RTS) frame;
sending a clear to send (CTS) frame to the first device; and
guaranteeing an interframe space (IFS) accuracy between the PPDU carrying the received beacon and the PPDU carrying the forwarded beacon to be same as the IFS accuracy of the CTS frame and the MU-RTS frame.

6. The method of claim 1, further comprising:
adjusting a timestamp of the forwarded beacons based upon a timestamp in the received beacon, a length of the beacon, a predefined interframe space (IFS) time, and a number of hops between the first device and the relay device.

7. The method of claim 1, wherein the forwarded beacon includes an indication that the forwarded beacon is a forwarded beacon.

8. The method of claim 1, wherein the forwarded beacon only carries information of the first device.

9. The method of claim 8, further comprising:
sending a broadcast management frame announcing the information of a relay station to the second device.

10. The method of claim 1, wherein the forwarded beacon carries information of the first device and the relay device.

11. The method of claim 1, wherein forwarding the beacon to the second device using a backoff procedure and a target beacon transmission time (TBTT) of the first device.

12. The method of claim 1, wherein forwarding the beacon to the second device using a backoff procedure and a target beacon transmission time (TBTT) of the relay device.

13. The method of claim 1, further comprising:
receiving first block acknowledge from the second device indicating that a PHY protocol data unit (PPDU) from the first device was received by the second device; and
transmitting a second block acknowledge to the first device indicating that a PHY protocol data unit (PPDU) from the first device was received by the second device.

14. A method of determining by a station whether to use a relay station in communication with an access point, comprising:
receiving an ultra-high reliability (UHR) PHY protocol data unit (PPDU) from the access point;
determining a first received signal strength indicator (RSSI) of the access point based on the received UHR PPDU from the access point;
receiving a PPDU from a first relay station;
determining a second RSSI of the first relay station based on the received PPDU from the relay station; and
determining whether to use the relay station to communicate with the access point based upon the first RSSI and the second RSSI.

15. The method of claim 14, further comprising:
receiving a PPDU from a second relay station;
determining a third RSSI of the second relay station based on the received PPDU from the second relay station; and
determining whether to use the first relay station or the second relay station to communicate with the access point based upon the second RSSI and the third RSSI.

16. A method of broadcasting a beacon by an access point to a relay station in a basic service set, comprising:
sending an announcement to the relay station indicating whether the relay station is to forward a received beacon to a leaf station;
sending a multi-user request to send (MU-RTS) frame;
receiving a clear to send (CTS) frame from the relay station; and
sending a beacon to the relay station.

17. The method of claim 16, wherein sending the beacon to the relay station includes sending an ultra-high reliability (UHR) PHY protocol data unit (PPDU) to the relay station that announces forwarding of the beacon.

18. The method of claim 17, wherein a SERVICE field of the UHR PPDU is configured to carry the beacon transmitted by the access point.

19. The method of claim 17, further comprising:
receiving a block acknowledge from the relay station indicating a reception of the UHR PPDU by the relay station.

20. The method of claim 17, further comprising:
receiving block acknowledge from the relay station indicating a reception of the UHR PPDU by the relay station.
